(19) United States
(12) Patent Application Publication
(10) Pub. No.: US 2022/0142447 A1
(43) Pub. Date: May 12, 2022

(54) MOPPING SYSTEM

(71) Applicant: Khaled Basheer, Cary, NC (US)

(72) Inventor: Khaled Basheer, Cary, NC (US)

(21) Appl. No.: 17/093,700

(22) Filed: Nov. 10, 2020

(51) Int. Cl. A47L 13/254; B25G 3/38; A47L 13/16

(52) U.S. Cl. CPC A47L 13/254; A47L 13/16; B25G 3/38

(57) ABSTRACT

Mopping system includes a mop head configured for receiving therein a mop pad that detachably engages with the mop head, wherein a combined volumetric mass density of the mop head and mop pad is at least 4 grams/cm³. A mop handle pivotably attaches to a center section of the mop head.

### TECHNICAL FIELD

The present invention relates generally to a cleaning device, and specifically to a mopping system for cleaning floors.

### BACKGROUND ART

Mops are classified in two main divisions as either a wet mop or a dry mop. A wet mop is commonly used to clean kitchen and bathroom floors. The wet mop usually has a sponge or cloth head that can be put in water with a detergent or other cleaner and rinsed when cleaning is finished. A dry mop, also called as dust mop, is characterized by a large, flat head that can be pushed easily over a floor surface. Strings making up the head of a dry mop pick up dust, lint, and hair as the dry mop glides across the floor. In a typical mop, a swivel at the point where the mop head joins the handle allows the mop to be pushed under beds and in other places with limited access. A detachable mop pad can be machine-washed.

When cleaning a floor with a mop, an operator may often apply downward pressure on the mop handle in order to increase the friction created between a bottom surface of the mop pad and the floor to thereby obtain an improved cleaning effect. This maneuver becomes particularly beneficial when the floor being cleaned is quite soiled or dirty. However, applying such downward pressure over an extended period can be tiresome to the operator leading to quick exhaustion of the operator or inadequate cleaning or both.

Accordingly, opportunities exist for providing a solution for mopping floors that overcomes the limitations mentioned above.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to one or more embodiments, a system for mopping is provided herein. The mopping system includes a mop head configured for receiving therein a mop pad that detachably engages with the mop head wherein a volumetric mass density of the mop head is at least 4 grams/cm³. A mop handle is pivotably attached to the mop head.

According to one or more embodiments, at least 75% by weight of the mop head is formed of a metallic substance comprising one or more of: iron, lead, zinc, chromium, manganese, tin, copper, nickel and alloys thereof.

According to one or more embodiments, the mop head comprises one or more of: carbon-based materials, silicon-based materials, plastic-based materials, wood-based materials, glass-based materials, stone-based materials, and the like.

According to one or more embodiments, the mop head defines a center section interconnecting a left section and a right section,

According to one or more embodiments, each of the left section and the right section pivotable about a lateral edge of the center portion.

According to one or more embodiments, a free end of the left section and a free end of the right section are configured to pivot downwards in a direction opposite to a direction in which the handle extends.

According to one or more embodiments, the mop pad includes folded flaps at each end, each folded flap configured for receiving a respective portion of the left section and the right section.

According to one or more embodiments, the volumetric mass density of the mop head is at least 5 grams/cm³.

According to one or more embodiments, the volumetric mass density of the mop head is at least 6 grams/cm³.

According to one or more embodiments, the volumetric mass density of the mop head is at least 7 grams/cm³.

According to one or more embodiments, the mop head is configured for use as one or more of: a dry mop, and a wet mop.

According to one or more embodiments, a bottom surface of the mop head is substantially flat.

According to one or more embodiments, the metallic substance comprises at least 90% by weight of the mop head.

According to one or more embodiments, the metallic substance comprises at least 95% by weight of the mop head.

According to one or more embodiments, the metallic substance comprises at least 98% by weight of the mop head.

According to one or more embodiments, a system for mopping is provided herein. The mopping system comprises a mop head defining a center section interconnecting a left section and a right section, each of the left section and the right section pivotable about a lateral edge of the center portion. The mopping system further comprises a mop pad that detachably engages with the mop head and a mop handle pivotably attached to the center section of the mop head. A combined volumetric mass density of the mop head and the mop pad is at least 4 grams/cm³.

According to one or more embodiments, the mop pad comprises one or more of sand, beads and gel.

According to one or more embodiments, the mop head is formed of a metallic substance comprising one or more of: iron, lead, zinc, chromium, manganese, tin, copper, nickel and alloys thereof.

According to one or more embodiments, a system for mopping is provided herein. The mopping system comprises a mop head formed of a metallic substance such that a volumetric mass density of the mop head is at least 4 grams/cm³. The mop head defines at least two sections pivotably attached to each other. A mop pad detachably engages with the mop head, and a mop handle pivotably attaches to the mop head.

According to one or more embodiments, the metallic substance comprises one or more of: iron, lead, zinc, chromium, manganese, tin, copper, nickel and alloys thereof.

### BRIEF DESCRIPTION OF THE DRAWINGS

In order to describe the technical solutions of the examples of the present invention more clearly, the figures required to be used for the examples will be briefly introduced below. It should be understood that the following figures only show some examples of the present invention, and thus shall not be construed as limiting the scope thereof; and for a person skilled in the art, further relevant figures could also be obtained according to the figures without using inventive efforts.

FIG. 1 illustrates a perspective view of a mopping system, according to one or more embodiments of the presently disclosed subject matter.

FIG. 2 illustrates a front plan view of a mopping system, according to one or more embodiments of the presently disclosed subject matter.

FIG. 3 illustrates a top perspective view of a mop head that forms part of a mopping system, according to one or more embodiments of the presently disclosed subject matter.

FIG. 4 illustrates a side perspective view of a mop head and a mop pad prior to removably attaching the mop pad to the mop head, according to one or more embodiments of the presently disclosed subject matter.

FIG. 5A illustrates a side perspective view of a top surface of a mop pad, and FIG. 5B illustrates a side perspective view of a bottom surface of the mop pad, according to one or more embodiments of the presently disclosed subject matter.

### DETAILED DESCRIPTION OF THE EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

When cleaning a floor with a mop, an operator often has to apply downward pressure on the mop handle to increase the friction between a bottom surface of the mop pad and the floor to thereby obtain an optimal or better cleaning effect. This maneuver becomes particularly essential when the floor being cleaned is quite soiled or dirty. However, applying such downward pressure over an extend period of time can be tiresome leading to quick exhaustion of the operator or inadequate cleaning or both. Further, the downward pressure may be applied in an inconsistent manner thereby resulting in uneven and inadequate cleaning.

Embodiments of the presently disclosed subject matter provide for a mopping system that overcomes limitations of the art by providing for a mop head formed of or composed of a high-density material such as a metal or a metal alloy. A mop head formed or composed of a high-density material can advantageously impart uniform downward pressure by way of the gravitational force exerted onto the heavy mop head by the earth's gravitational force; this in turn can result in a substantially uniform cleaning effect wherein less effort is needed to be expended by the operator of the mopping system to accomplish cleaning of the floor in an adequate manner. The operator may apply little to no downward pressure while mopping the floor and still obtain adequate cleaning in a uniform manner by use of the mopping system as described herein since the weight of the mop head a substantial portion of which includes a high-density material provides for a uniform downward pressure thereby improving the effectiveness of the mopping operation. In some embodiments, the mop pad (in addition to the mop head) may include high-density elements such as for example, sand, beads, gel, and similar other materials to further increase the gravitational force exerted onto the combination of a heavy mop head and a heavy mop pad by the earth's gravitational force.

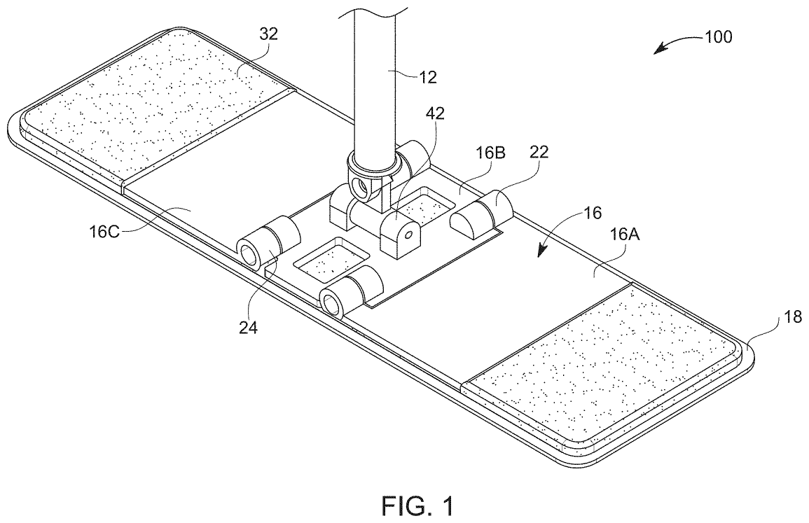

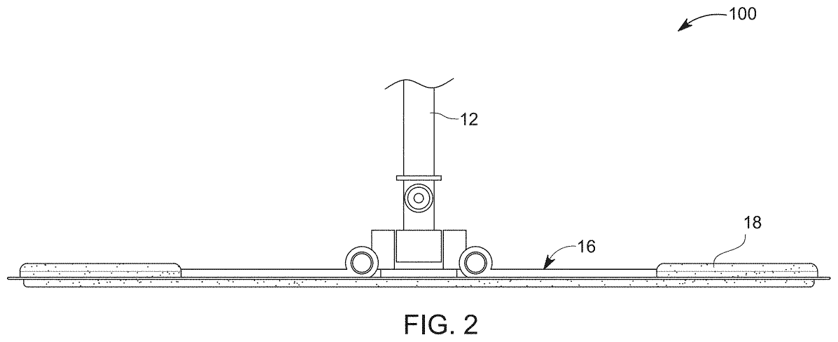

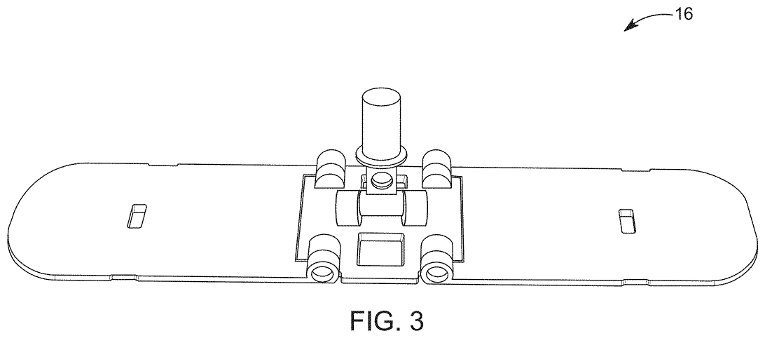

Referring to FIG. 1 through FIG. 5, a mopping system 100 (alternately referred to as “system 100” or simply “system”) is provided according to one or more embodiments of the presently disclosed subject matter. In various embodiments, mopping system 100 includes a mop head 16 configured for receiving therein a mop pad 18. In various embodiments, mop pad 18 detachably engages with mop head 16. In one embodiment, at least 75% by weight of mop head 16 is formed of a metallic substance such that a volumetric mass density of the mop head is at least 4 grams/cm³. A mop handle 12 pivotably attached to center section 16B of mop head 16. In one embodiment, mop handle 12 pivotably attaches to center section 16B of mop head 16 by way of mechanical attachment 42.

In various embodiments, the metallic substance that mop head 16 is formed of can comprise one or more of iron, lead, zinc, chromium, manganese, tin, copper, nickel, and similar other metals and alloys thereof. In some embodiments, the metallic substance can comprise an alloy that includes at least one element picked from the following table:

| Name | Symbol | Density | |
|---|---|---|---|
| Aluminum | Al | 2.702 | g/cc |
| Zinc | Zn | 7.13 | g/cc |
| Chromium | Cr | 7.19 | g/cc |
| Tin | Sn | 7.31 | g/cc |
| Manganese | Mn | 7.43 | g/cc |
| Iron | Fe | 7.874 | g/cc |
| Cobalt | Co | 8.9 | g/cc |
| Nickel | Ni | 8.9 | g/cc |
| Copper | Cu | 8.96 | g/cc |
| Lead | Pb | 11.35 | g/cc |

According to various embodiments, mopping system 100 as disclosed herein can accordingly include mop head 16 formed of a metallic substance such that a volumetric mass density of the mop head is at least 4 grams/cm³. In one embodiment, the volumetric mass density of the mop head is at least 5 grams/cm³. According to one or more embodiments, the volumetric mass density of the mop head is at least 6 grams/cm³. In one embodiment, the volumetric mass density of the mop head is at least 7 grams/cm³. In one embodiment, the volumetric mass density of the mop head is at most 10 grams/cm³. In one embodiment, the volumetric mass density of the mop head is at most 11 grams/cm³. In one embodiment, the volumetric mass density of the mop head is at most 12 grams/cm³. In one embodiment, the metallic substance comprises at least 90% by weight of the mop head. In one embodiment, the metallic substance comprises at least 95% by weight of the mop head. In one embodiment, the metallic substance comprises at least 98% by weight of the mop head. In one example, at least 90% of the metallic substance is iron. In one example, at least 90% by weight of the mop head is iron. In one example, at least 95% by weight of the mop head is iron. In one example, at least 98% by weight of the mop head is iron. In one example, at least 95% by weight of the mop head is steel. In one example, at least 98% by weight of the mop head is steel. According to one or more embodiments, at least 90% by weight of the mop head comprises one or more of: iron, lead, zinc, chromium, manganese, tin, copper, nickel and other metals and alloys thereof. In some embodiments, the metallic substance includes a small percentage of zinc to protect the mop head from water damage.

According to various embodiments, a combined volumetric mass density of the mop head and the mop pad is at least 4 grams/cm³. In one embodiment, the combined volumetric mass density of the mop head and the mop pad is at least 5 grams/cm³. According to one or more embodiments, combined volumetric mass density of the mop head and the mop pad is at least 6 grams/cm³. In one embodiment, combined volumetric mass density of the mop head and the mop pad is at least 7 grams/cm³. In one embodiment, combined volumetric mass density of the mop head and the mop pad is at most 10 grams/cm³. In one embodiment, the combined volumetric mass density of the mop head and the mop pad is at most 11 grams/cm³. In one embodiment, the combined volumetric mass density of the mop head and the mop pad is at most 12 grams/cm³. In one embodiment, the metallic substance comprises at least 90% by weight of the mop head and the mop pad. In one embodiment, the metallic substance comprises at least 95% by weight of the mop head and the mop pad. In one embodiment, the metallic substance comprises at least 98% by weight of the mop head and the mop pad. In one example, at least 90% of the metallic substance is iron. In one example, at least 95% by weight of the mop head is iron. In one example, at least 98% by weight of the mop head is iron. In one example, at least 90% of the metallic substance is steel. In one example, at least 95% by weight of the mop head is steel. In one example, at least 98% by weight of the mop head is steel. According to one or more embodiments, at least 90% by weight of the mop head comprises one or more of: iron, lead, zinc, chromium, manganese, tin, copper, nickel and other metals and alloys thereof. In some embodiments, the metallic substance includes a small percentage of zinc to protect the mop head from water damage.

In at least one embodiment, the mop head is formed of 100% carbon-based materials. In at least one embodiment, the mop head is formed of 100% silicon-based materials. In at least one embodiment, 100% of the mop head is formed of carbon-based materials and silicon-based materials. In at least one embodiment, the mop head includes a combination of metallic substances, carbon-based materials and silicon-based materials. In at least one embodiment, the mop head is formed of one or more materials such as: silicon-based materials, carbon-based materials, metal-based materials, plastic-based materials, wood-based materials, glass-based materials, stone-based materials, and the like.

In various embodiments, mop head 16 defines a center section 16B interconnecting a left section 16A and a right section 16C. According to at least one embodiment, each of left section 16A and right section 16C is pivotable about a respective lateral edge of center section 16B. According to at least one embodiment, left section 16A is pivotable about a lateral edge of center section 16B by way of left swivel 22. According to at least one embodiment, right section 16C is pivotable about a lateral edge of center section 16B by way of right swivel 24. However, mop head 16 does not necessarily need to include three sections; accordingly, in at least one embodiment, mop head 16 includes only left section 16A and right section 16C connected by a mechanical arrangement whereby center section 16B is omitted. In one embodiment, mop head 16 includes a non-collapsible single section wherein mop pad 18 includes elasticity such that mop pad 18 can be fitted onto mop head 16 formed as a non-collapsible single section.

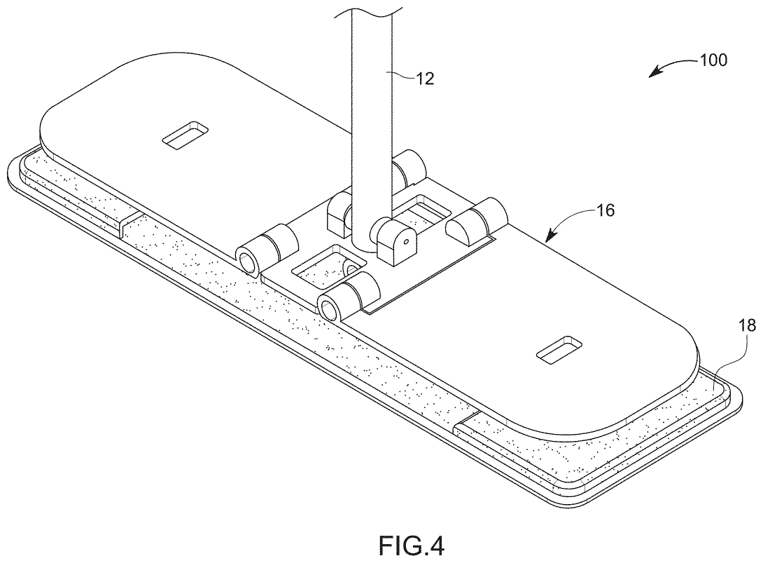

As illustrated, for example, in FIG. 3 and FIG. 4, according to one embodiment, a free end of left section 16A and a free end of right section 16C have curved edges. Further, the free end of left section 16A and the free end of right section 16C are configured to pivot downwards in a direction roughly opposite to a direction in which mop handle 12 extends as illustrated, for example, in FIG. 4. According to one or more embodiments, a bottom surface of mop head 16 is substantially flat.

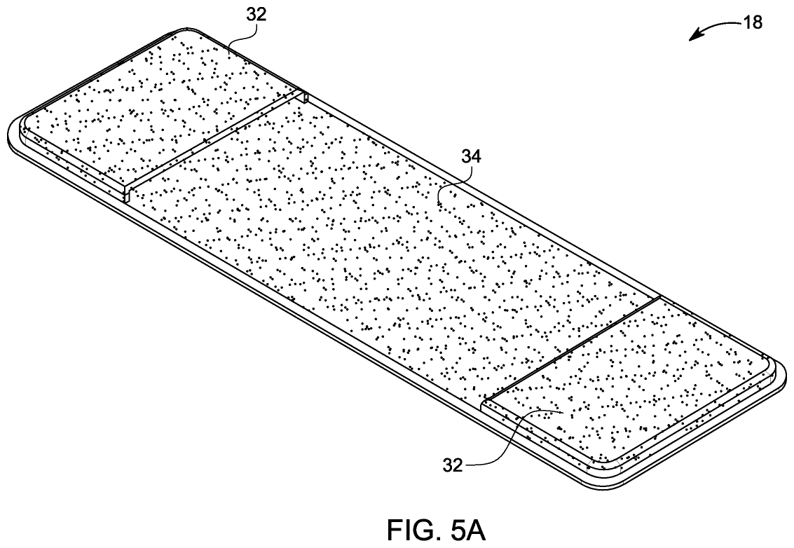

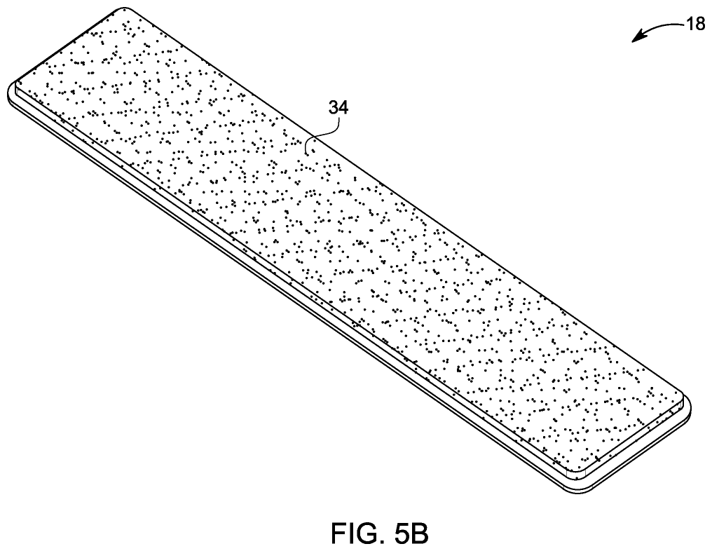

As illustrated, for example in FIG. 5A, in at least one embodiment, mop pad 18 includes folded flaps 32 provided at each end thereof. Each folded flap 32 is configured for receiving a respective portion of left section 16A and a portion of right section 16C. For example, during operations, an operator can cause the free ends of left section 16A and right section 16C to pivot downwards, i.e., pivot in a direction opposite to a direction in which mop handle 12 extends. Following this, the operator can slide the free ends of left section 16A and right section 16C into a respective folded flap 32. When the operator then proceeds to place the bottom surface of mop pad 18 (the bottom surface of mop pad 18 is shown in FIG. 5B) on the floor, the action has the effect of automatically causing the free ends of left section 16A and right section 16C to swivel upwards whereby mop head 16 straightens into the form of a single continuous lateral platform such that mop head 16 reaches the disposition illustrated in FIG. 1.

In various embodiments, mop handle 12 is made with tubular steel, wood, fiberglass, aluminum, and similar other materials. In one embodiment, mop handle 12 can take the form of tubular steel coated with plastic or can be chrome plated.

In various embodiments, mechanical attachment 42 can take the form of a swivel, or any suitable mechanical attachment that can vary widely depending on the type, shape, and use of mopping system 100. Mechanical attachment 42 can be made of steel wire, plated metal, or plastic that supports the shape of mop head 16 and mop pad 18. Mop head 16 need not necessarily swivel about mop handle 12; mechanical attachment 42 linking mop head 16 to mop handle 12 may be a single plate, a double hinged plate that folds like a butterfly to squeeze the mop dry, or a roller mechanism that squeezes sections of mop head 16 between two rollers. In cases where a roller mechanism is present, the roller mechanism may be integrated into the frame along the major axis (the widest portion) of mop head 16 and include a lever that parallels the handle so an operator operating mopping system 100 can activate the hinge to squeeze the mop without bending down. Attachments can be provided on mopping system 100 configured as a wet mop that further allow for removing and replacing mop pad 18 when it gets dirty.

According to one or more embodiments, one or more of mop head 16 and mop pad 18 are configured for use of mopping system 100 as a dry mop. According to at least one embodiment, one or more of mop head 16 and mop pad 18 are configured for use of mopping system 100 as a wet mop. Mop pad 18 can be fabricated such that it is durable and can be cleaned many times before it must be replaced. In one embodiment, mop pad 18 includes nylon material that hold static electricity charges and are effective as the static cleaner cloths in attracting and holding dust and hair. In one embodiment, mop pad 18 can be primarily made of yarn consisting of natural or synthetic fibers like cotton or nylon. The yarn can be attached to a carrier substrate, which is almost rigid and holds the shape of the mopping surface. The carrier substrate can be fabric, vinyl, or molded plastic. Mop pad 18 in the form of a wet mop can be made of loosely woven yarn or sponge. Like dry mops, the yarn of mop pad 18 to be used as part of a wet mop may be made of natural or synthetic materials. According to one embodiment, the mop pad can include one or more of sand, beads and gel in order to increase the weight or the volumetric density of the mop pad to thereby further enhance the effectiveness of mopping system 100.

When using mopping system 100 for cleaning a floor or substrate, an operator may not need to press down the mop rod as a result of which the burden of the operator is lightened, and the effect of labor saving is achieved.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A mopping system comprising:
a mop head configured for receiving therein a mop pad that detachably engages with the mop head,
wherein a bottom surface of the mop head is substantially flat,
wherein the mop head is formed of a high-density material having a volumetric mass density of is at least 4 grams/cm³; and
a mop handle pivotably attached to the mop head;
wherein the high-density material of the mop head and the substantially flat bottom surface of the mop head each contribute to imparting a substantially uniform downward pressure to provide a substantially uniform cleaning effect on a floor being cleaned.

2. The mopping system of claim 1, wherein at least 75% by weight of the mop head is formed of a metallic substance comprising one or more of: iron, lead, zinc, chromium, manganese, tin, copper, nickel and alloys thereof.

3. The mopping system of claim 1, wherein the mop head comprises one or more of: carbon-based materials, silicon-based materials, plastic-based materials, wood-based materials, glass-based materials, and stone-based materials.

4. The mopping system of claim 1, wherein the mop head defines a center section interconnecting a left section and a right section,

5. The mopping system of claim 4, wherein each of the left section and the right section pivotable about a lateral edge of the center portion.

6. The mopping system of claim 5, wherein a free end of the left section and a free end of the right section are configured to pivot downwards in a direction opposite to a direction in which the handle extends.

7. The mopping system of claim 5, wherein the mop pad includes folded flaps at each end, each folded flap configured for receiving a respective portion of the left section and the right section.

8. The mopping system of claim 1, wherein the volumetric mass density of the mop head is at least 5 grams/cm³.

9. The mopping system of claim 1, wherein the volumetric mass density of the mop head is at least 6 grams/cm³.

10. The mopping system of claim 1, wherein the volumetric mass density of the mop head is at least 7 grams/cm³.

11. The mopping system of claim 1, wherein the mop head is configured for use as one or more of: a dry mop, and a wet mop.

12. (canceled)

13. The mopping system of claim 2, wherein the metallic substance comprises at least 90% by weight of the mop head.

14. The mopping system of claim 2, wherein the metallic substance comprises at least 95% by weight of the mop head.

15. The mopping system of claim 2, wherein the metallic substance comprises at least 98% by weight of the mop head.

16. A mopping system comprising:
a mop head formed of a high-density material defining a center section interconnecting a left section and a right section,
each of the left section and the right section pivotable about a lateral edge of the center section
wherein a bottom surface of the mop head is substantially flat;
a mop pad that detachably engages with the mop head; and
a mop handle pivotably attached to the center section of the mop head,
wherein a combined volumetric mass density of the mop head and the mop pad is at least 4 grams/cm³;
wherein the high-density material of the mop head and the substantially flat bottom surface of the mop head each contribute to imparting a substantially uniform downward pressure to provide a substantially uniform cleaning effect on a floor being cleaned.

17. The mopping system of claim 16, wherein the mop pad comprises one or more of sand, beads and gel.

18. The mopping system of claim 16, wherein the mop head is formed of a metallic substance comprising one or more of: iron, lead, zinc, chromium, manganese, tin, copper, nickel and alloys thereof.

19. A mopping system comprising:
a mop head formed of a metallic substance such that a volumetric mass density of the mop head is at least 4 grams/cm³, the mop head defining at least two sections pivotably attached to each other
wherein a bottom surface of the mop head is substantially flat;
a mop pad that detachably engages with the mop head; and
a mop handle pivotably attached to the mop head;
wherein the metallic substance of the mop head and the substantially flat bottom surface of the mop head each contribute to imparting a substantially uniform downward pressure to provide a substantially uniform cleaning effect on a floor being cleaned.

20. The mopping system of claim 19, wherein the metallic substance comprises one or more of: iron, lead, zinc, chromium, manganese, tin, copper, nickel and alloys thereof.
